(19) United States
(12) Patent Application Publication
(10) Pub. No.: US 2009/0313682 A1
(43) Pub. Date: Dec. 17, 2009

(54) Enterprise Multi-interceptor Based Security and Auditing Method and Apparatus

(76) Inventors: Saeed Rajput, Coral Springs, FL (US); Basit Hussain, Odessa, FL (US)

Correspondence Address: Basit Hussain, 16467 Turnbury Oak Dr., Odessa, FL, 33556, US

(21) Appl. No.: 12/539,189

(22) Filed: Aug. 11, 2009

Related U.S. Application Data
(63) Continuation-in-part of application No. 10/905,481, filed on Jan. 6, 2005.
(60) Provisional application No. 60/481,863, filed on Jan. 6, 2004.

(51) Int. Cl. H04L 9/32

(52) U.S. Cl. 726/4; 726/29; 726/7

(57) ABSTRACT

A method of auditing network communications and applying external policy controls enforced by network connectivity including the steps of caching a plurality of packets, tagging each packet with a unique identifier, assembling an array of packets into a readable payload and evaluating the payload contents.

### CROSS REFERENCE TO RELATED APPLICATIONS

This application is a continuation-in-part of application Ser. No. 10/905,481 entitled: “Enterprise Software Security and Auditing Method and Apparatus”, file by the same inventors on Jan. 6, 2005 now abandoned that claims priority to U.S. Provisional Patent Application No. 60/481,863 entitled: “Enterprise Software Security and Auditing Method and Apparatus”, filed by the same inventors on Jan. 6, 2004.

### BACKGROUND

Securing access to enterprise resources is a balancing act between usability and control. Security does not come in a shrink-wrapped box. It requires vigilance, persistence, care, and effort. The process starts with risk and vulnerability assessment of the enterprise's assets followed by the security policy definition. When business needs require dispensing data to the Internet and sharing information with partner networks, a unique set of security challenges that cannot be solved by the traditional solutions of firewalls and virtual private networks is presented. In addition to other characteristics, enterprise security policies determine what resources must be available, to whom, and under what circumstances. Policy determination is followed by developing security architecture to implement the defined policy. The architecture is implemented with strategically placed infrastructure components such as firewalls, authentication tools, and intrusion detection systems. Security policy is also implemented in part by access control mechanisms, software patch update procedures, regular security audits, predefined incident response procedures, and security awareness programs. These implementations are designed to reduce the overall security risk of the organization. It is not possible to render an enterprise completely risk free, as a residual risk always remains. However, properly selecting and implementing the correct security procedures and prioritizing the assets protection can minimize such residual risk.

The implementation procedures outlined above are very complex due to the inherent complexity associated with the distributed and diverse nature of most enterprise networks. Consequently, there are risks due to human errors and omissions. Some procedures may be desirable but deliberately omitted from the corporate policy architecture because they are deemed prohibitively laborious. Tools that make it easier to manage and centralize the policies can simplify these procedures. By reducing management complexity, and increasing automation and centralization, these tools can increase the intrinsic security value by further reducing the errors and making complex procedures feasible.

The policy of securing a network from outside attacks is not enough for an enterprise serving information to its customers and partners. The corporate security policy needs to consider protection from the inside-out in addition to protection from outside the network. For seven years, the Computer Security Institute (CSI) and the FBI have conducted an annual survey of the types of attacks companies' experience. Dishonest and disgruntled employees top the list at about 75% (in year 2002) as the most likely source of attack. Furthermore, insider attacks typically fall into the most expensive categories. This report also suggests that during an economic downturn insiders, (i.e. employees, ex-employees, contractors, and ex-contractors) are under even greater pressure to commit fraud, theft of proprietary information, or sabotage.

Current access control in a corporation utilizes a centralized authentication system. There are several problems with existing implementations known in the art. Even though the authentication is centralized, authorization, and therefore, access control is still distributed. Access control lists are usually kept at the application or the server running the application making it exponentially difficult to implement and monitor security policy as the number of applications grows. Additionally, after the authentication has taken place, the security of transactions depends on the applications. Usually most applications were not designed with security in mind. Such transactions are usually open to man-in-the middle, data corruption, replay and repudiation attacks. Most systems known in the art rely on password authentication. Passwords are well known to be the weakest form of authentication. In addition, these systems are usually not flexible to allow multiple types of credentials (e.g. certificates, hardware tokens, or biometrics) and cannot change the privileges assigned to the users based on type of credentials that were presented. Due to the design of prior art systems it is rather cumbersome to implement a new security policy since many access control lists have to be modified manually. As such, the security policy cannot be modified dynamically and it is impossible to implement a more complex context based security policy involving more than one application.

There are some prior-art efforts that claim to provide application security, however these efforts fail to address all the security needs in a comprehensive manner. Prior art systems address logging and security in different contexts, do not comprehensively address authentication and authorization, and do not include support for incident response. These efforts usually require significant changes to the existing applications. Since organizations have made heavy investments into those applications, they end up neglecting security due to the huge investment required and the fear of disruption of ongoing operations.

Conventional functional security components can be classified into three main categories: (1) Firewalls, (2) Intrusion Detection Systems (IDS) and (3) Virtual Private Networks (VPN).

Firewalls are effective at blocking access to corporate networks. However, firewalls must allow data for certain applications to flow through to permit business over the Internet. Firewalls typically analyze the header information, such as the IP addresses and ports, to determine blocking decisions. Each port is usually associated with a specific application; however this is not a requirement. Most firewall solutions will allow administrators to reconfigure any other port. Because firewalls do not look at the application data within an IP packet, they cannot verify that the data on a port really belongs to the intended application. Hackers can run illegal applications on “legal” ports to disguise their applications as legal. Exploiting this inherent weakness in firewall systems, insiders are able to open security holes in corporate networks.

As an example, HTTP protocol is designed to provide web services to users. However, widely available programming techniques enable the HTTP protocol to carry encapsulated TCP/IP packets. Since the HTTP headers are correct, a firewall will simply assume that the content is safe and will pass the data stream to a receiving system. The receiver then de-encapsulates the contents back into TCP/IP packets, thus making the HTTP connection a conduit for a full-fledged bi-directional connection between two networks. Without actively inspecting the contents of the traffic, it is impossible to determine the real nature of the traffic. As such, firewalls do not provide the integrity or confidentiality service on the data being exchanged. If the data is confidential, it needs to be protected by the application itself or by some other means.

Additionally, firewalls do not provide authentication services or authorization services. Without authentication services, it is impossible to verify the identity of a user. Without authorization services, it is impossible to verify if the user is authorized to access a specific application. Firewalls are also not capable of providing granular access control in which just part of the application functionality is opened to specific groups of users and is dependent on value of the parameters.

Finally, firewalls do not predict or record suspicious activity or send alerts or alarms unless they are bundled with an intrusion detection component.

Intrusion detection systems (IDSs) detect possible unusual network behavior such as computer attacks or misuse and send appropriate alerts when certain pre-defined conditions have been met. IDSs are configured with rules and events to satisfy enterprise policy. When the IDS detects these events, an alert is issued.

There are three basic techniques used to IDSs to detect intruders: 1) anomaly detection, 2) misuse detection or signature detection, and 3) target monitoring.

Anomaly detection techniques discover abnormal behavioral patterns. An IDS classifies anything that deviates from “normal” as a possible intrusion. For instance, if a user logs on and off of a machine 25 times a day rather than the normal 3 or 4, or a company accountant suddenly starts accessing human resource systems or compiling code, the IDS will alert the management.

Misuse detection, also referred to as signatures, utilizes known patterns of unauthorized behavior. For example, “three failed logins” is a suspicious pattern on a host system log file, and so is the string “/etc/passwd” in the FTP traffic on the network.

Target Monitoring techniques require watching for specified file or resource modification to discover the actions of an intruder after a successful break-in.

The two basic IDS classifications are host-based (HIDS) and network-based (NIDS). Host-based IDS examines data held on an individual computer or host. Network-based IDS monitors the data exchanged between computers on the network. An NIDS is a “drop-in” implementation that requires little effort from administrators. HIDS on the other hand requires an agent on each host. In the examples discussed above, “25 logins a day rather than the normal “3 or 4” and “three failed logins” are HIDS rules while others can be NIDS rules. HIDS is seen as a more effective system because it identifies the raw activity that is not mixed with traffic from other users. Thus, an HIDS is capable of detecting insider malicious activity. A pure NIDS or a firewall simply cannot detect or block such activity. An MIT study funded by DARPA of the various NIDS products found that they typically only detect between 60% and 80% of attacks taking place across the wire.

IDS products are unable to bridge all the gaps left open by firewalls. An IDS system is only as good as the model identifying the rule set and events defined for unacceptable behavior. Theoretically, if all of the unacceptable behavior could be defined, every occurrence of such behavior would result in an alarm and no alarm would occur for legitimate uses of the enterprise resources. In the real world, these two goals are contradictory. The compromise is to raise alarms only on highly likely intrusions, and leave the rest for the administrators to monitor manually. The volume of data produced by the IDS can easily overwhelm the monitoring staff.

The speed of the network is also an issue for security. The NIDS monitors sit alongside the networking stream, not in the way of the traffic. Therefore, they cannot throttle traffic at higher data rates. On a very busy network an NIDS is able to analyze only a fraction of packets passing through the network. With this limitation, an intruder can first saturate the network artificially and then attack, with little fear of detection. Additionally, NIDSs cannot review encrypted data, since the keys are not available. Thus, the attacks hidden in encrypted connections cannot be detected. This creates a dilemma, since encryption is essential for transporting confidential information, but it also makes intrusion detection impossible on that traffic.

Theoretically, a hybrid IDS consisting of components from both an HIDS and a NIDS can be more effective because such a system will have the ability to detect more complex attacks based on both local and network activity. However, such a system will remain difficult to manage due to its distributed nature. In such a hybrid system, the agents are designed to run on all hosts, close to the intruder. Careful insiders can bypass these agents or can clean up traces of intrusion before the IDS is able to detect the suspicious activity. Furthermore, due to the diverse nature of the enterprise network on which a variety of operating systems are running, including numerous applications from different vendors, correlating and reconciling the logs and events in many different log formats and different time references can be a formidable task.

An HIDS cannot provide real-time, or near real-time alerts, due to the distributed and inherent design that results from analyzing logs off-line. An HIDS also consumes significant resources.

In addition to the issues addressed above, IDSs cannot compensate for weak identification and authentication mechanisms, or conduct investigations of attacks without human intervention. Such a system cannot compensate for weaknesses in network protocols, or improve upon the quality of logs that the system or agents provide. Additionally, an NIDS cannot always deal with problems involving packet-level attacks.

As such, neither a firewall system nor an intrusion detection system is capable of providing data integrity or confidentiality services acceptable for enterprise data over the Internet. In providing access to enterprise data over the Internet it is imperative that transit data be protected. Accordingly, data protection is needed between the distributed branches of the same enterprise (intranet) or between business partners (extranet). Data protection is also necessary for communications with end users, and road warriors.

There are four mechanisms known in the art for protecting information in transit on the Internet: 1) IPSec usually used for VPNs, 2) SSH, 3) SSL, and 4) S/MIME. These protocols all use cryptographic algorithms to provide secure transport of data. The most suitable protection mechanism depends upon the needs of the specific network.

A Virtual Private Network (VPN) utilizes the Internet for secure communications between multiple partner sites, branch offices, and access by traveling employees. It is implemented by creating a secure tunnel between two end-points. All traffic across the tunnel is encrypted and each end-point is properly authenticated before the connection takes place. Utility of a VPN is limited to forming a secure connection. A VPN does not identify the type of data that is crossing the established tunnel. As such, a VPN still requires integration with a firewall to control the type of data that is allowed to cross between the two end-points.

IPSec protocol is one method of implementing VPNs, providing confidentiality, integrity, and authentication services at the IP level. IPSec defines a set of protocols for authentication, privacy, and data integrity while keeping the complexity hidden from the application and even the network infrastructure. IPSec also checks the integrity of transmitted packets to make sure they have not been tampered with en-route. The IPSec protocol protects the entire traffic that runs over the IP network, so it is appropriate when data from multiple applications is to be protected. It can be used to secure connections between multiple firewalls and routers, making it an optimum solution for intranets and extranets over which high volumes of data are exchanged between LANs.

However, the IPSec protocol does not support network protocols other than TCP/IP. As a standard, it does not specify a methodology for access control other than simple packet filtering. Moreover, because IPSec utilizes IP addressing as part of its authentication algorithm, it only protects the communication at the machine-to-machine level. It does provide for identify protection of the individual users.

SSL provides transport level security by providing confidentiality and data integrity services. SSL is also capable of providing bi-directional authentication. SSL is generally configured to provide authentication of the HTTP server only because web servers usually do not require authentication of the client browser. In practice, SSL is only used to secure the HTTP protocol.

Secure SHell (SSH) was designed to replace insecure telnet and ftp protocols. It allows users to securely access and control remote machines through telnet and ftp like sessions. SSH provides confidentially and data integrity service and can also be configured to provide authentication service. However, use of this protocol is limited to remote administration.

S/MIME is specifically designed for email applications providing confidentiality, data integrity, and non-repudiation services. S/MIME is appropriate when user-to-user non-repudiation and other services are desired for e-mail or for providing security when e-mail is the only application used between the two parties. S/MIME implementation issues include the relative difficulty with which mandatory digital certificates are requested, installed, maintained, and used.

Accordingly, what is needed in the art is an improved system and method that addresses the “internal” security needs of large enterprises while making it possible to centralize the event logging, and incident response activities.

### SUMMARY OF INVENTION

The present invention is a method of auditing communications on a network including the steps of caching a plurality of packets, tagging each packet with a unique identifier, assembling an array of packets into a readable payload and evaluating the payload contents. A security policy may be applied to the payload based on its contents, origin, destination or user.

In accordance with an embodiment of the invention, a method of providing network application security is provided including the steps of intercepting a request from a client to an application on a network, assigning a predetermined client privilege to the application dependent upon the intercepted request and forwarding the intercepted request to the application dependent upon the privilege assigned.

In a particular embodiment, the step of intercepting a request from a client to an application on a network further includes the steps of caching a plurality of intercepted data packets transmitted from the client in the request, tagging each packet with a unique identifier, assembling the plurality of packets tagged with the unique identifier into a readable payload and evaluating the payload contents. Accordingly, the packets are cached and then reassembled into a readable payload by the interceptors. The interceptors then analyze the payload and assert the privileges assigned to the client. It is within the scope of the present invention to provide for a variety of privileges, including a granular approach thereby assigning privileges to only particular access points of the application with optional limitation on the range of parameters within those access points as determined by the security policy of the enterprise.

In a specific embodiment, assigning the client privilege to the application is dependent upon the evaluated payload contents. The evaluated payload contents may include the origin of the payload, the destination of the payload or any of a variety of other identifying feature.

In accordance with an additional embodiment, authentication of the client requesting access to the application on the network is performed. The authentication process thereby including the steps of, intercepting the access request by the client to the application to obtain client identification information, providing the client identification information to a security service, obtaining the predetermined client credentials from a directory service, returning a challenge to the client from the security service based on the client credentials obtained, signing the returned challenge to prove client credentials, authenticating the client by verifying the signature from the client and returning a session object to the client verifying authentication. The client then utilizes this session object to gain access to the application through the interceptor. In a specific embodiment, the client request for authentication is logged into a central audit system by the interceptor.

A plurality of forms of client identification may be utilized for authentication purposes in accordance with the present invention. These forms of client identification include, but are not limited to, a password, a certificate or hardware token.

Utilizing the interceptors, the requests to various applications on the network, having a variety of protocols, can be logged into a centralized audit system. Accordingly, the logged results can be analyzed for usage patterns by the client for an individual application or the entire network. In logging the requests to a central audit system, the method in accordance with the present invention provides for caching a plurality of intercepted data packets transmitted from the client request, tagging each packet with a unique identifier, assembling the plurality of packets tagged with the unique identifier into a readable payload, evaluating the payload contents and logging the results of the payload evaluation.

In a preferred embodiment, each of the protocols active on the enterprise network has an associated interceptor. As such, the interceptor is specific to a network protocol and is effective in intercepting a request from a client utilizing a specific protocol. The system in accordance with the present invention, intercepts a plurality of application requests having a plurality of protocols and logs the requests with a centralized audit service having a common format.

In a particular embodiment, the method in accordance with the present invention is presented on a computer readable medium having computer-executable instructions for performing the method. The medium in accordance with the present invention is defined as being any computer memory, including but not limited to, floppy disk memory, hard disk memory, CD-ROM, flash RAM, RAM, and non-volatile RAM.

According to an embodiment of the present invention, a system for providing network application security is provided, including a protocol interceptor positioned between a client and an application on the network and a security server in communication with the interceptor to authenticate the client provide client privilege information to the interceptor. Utilizing this configuration, requests to the application from the client are intercepted and processed by the protocol interceptor. The interceptor then applies the privileges of the client and determines for flow of data to the application.

In a particular embodiment, the system may also include and audit service in communication with the interceptor to log the results of the data traffic between the client and the application.

In yet another embodiment, the system may include a directory server in communication with the security server to store the client privilege information and an incident response server to identify and report a failure on the network.

In addition to providing security for the enterprise network, a particular embodiment of the present invention provides for monitoring of the network traffic, independent of the security features. In accordance with this embodiment, a method of monitoring network data traffic between a client and an application is provided. The method includes, identifying a communication protocol associated with the application, intercepting a request from the client to the application, reconstructing the request into a common format, and presenting the reconstructed request for centralized logging. In intercepting the request from a client, the interceptor is effective in caching a plurality of data packets transmitted from the client request, tagging each packet with a unique identifier, and assembling the plurality of packets tagged with the unique identifier into a readable payload. In accordance with this method of monitoring, request to the enterprise network applications, under various protocols, can be consolidated and logged in a centralized audit system. The logged requests may then be analyzed for usage patterns and stored for future audit requirements.

To implement a method of monitoring network data traffic between a client and an application, a system is provided including, a protocol interceptor positioned between the client and the application, and a directory service in communication with the interceptor. Wherein, the directory service provides the roles and privileges of the client.

Accordingly, the present invention provides an improved system and method that addresses the “internal” security needs of large enterprises while making it possible to centralize the event logging, and incident response activities.

### BRIEF DESCRIPTION OF THE DRAWINGS

For a fuller understanding of the invention, reference should be made to the following detailed description, taken in connection with the accompanying drawings, in which:

FIG. 1 is a diagrammatic view of the location of various security protocols in the layered network model as is known in the prior art.

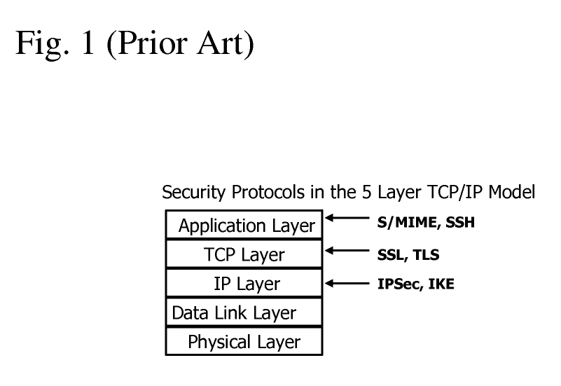

FIG. 2 is a diagrammatic abstract representation of a conventional enterprise application security architecture as is known in the prior art.

FIG. 3 is a diagrammatic view of an abstract representation of the proposed enterprise application security architecture in accordance with the present invention.

FIG. 4 is a flow diagram of an authentication request as made to the security service in accordance with the present invention.

FIG. 5 is a flow diagram of an initial client request to an application in accordance with the present invention.

FIG. 6 is a flow diagram of the handling of subsequent request made to applications in accordance with the present invention.

FIG. 7 is a diagrammatic abstract representation of the proposed granular access control of an enterprise application in accordance with the present invention.

FIG. 8 is a diagrammatic view of the enterprise security infrastructure of a particular embodiment in accordance with the present invention.

### DETAILED DESCRIPTION OF THE PREFERRED EMBODIMENT

This invention describes the concept of enterprise application security that complements other security components such as firewalls, IDS and VPNs designed to protect an organization's perimeters against undesired traffic and break-in attempts. While firewalls are an essential part of the overall security picture, their functionality is mostly limited to the network or transport layer and protecting an organization's perimeters against undesired traffic and break-in attempts. Therefore, they only protect the network from outside attacks. The effectiveness of most intrusion detection systems is limited when it comes to detection of long-term distributed attacks that target multiple applications or application servers simultaneously. The difficulty is in collecting and standardizing the format of security events so they can all be analyzed comprehensively. This problem is more severe when dealing with legacy applications.

Mission critical applications dispensing data to the Internet and sharing information with partner networks pose a completely new set of security requirements. The present invention addresses the “internal” security needs of large enterprises while making it possible to centralize the event logging, and incident response activities.

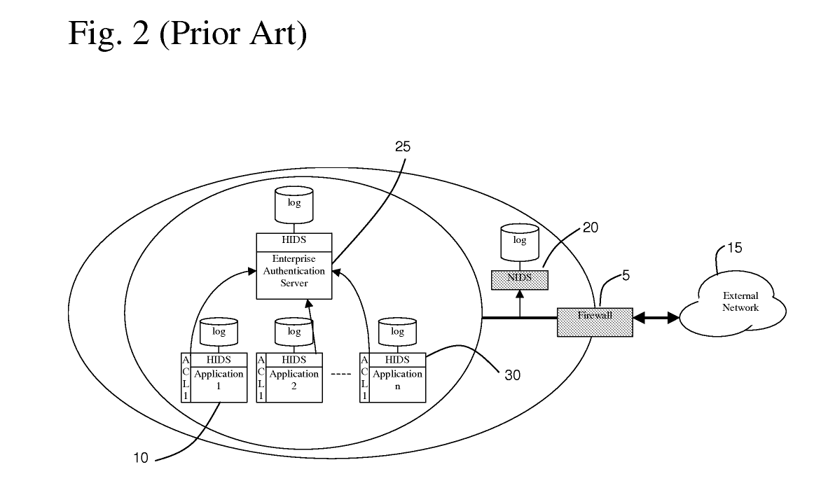

FIG. 2 provides an abstract representation of an enterprise network infrastructure known in the art that is considered well protected according to current security standards. Firewalls 5 are the first line of defense for such a network. They block undesired services. Depending on the partitioning of the network and corporate security policy, there could be a number of firewalls between the external network 15, and the internal applications 10. The Network Intrusion Detection System (NIDS) 20 monitors the traffic and looks for suspicious patterns. It does not block any access, but records occurrence of suspicious patterns. It may raise alarms if such activity crosses a threshold. The enterprise may have a central authentication server 25 that authenticates users. Many applications in the enterprise may use this authentication service. Some applications may require the users to provide more authentication credentials directly to them. Each application or server on the enterprise has its own access control list that maps authenticated users to privileges. Most applications rely on primitive Host Intrusion Detection System (HIDS) 30 based on OS logs. Such logs are usually not analyzed in real time, or near real time, and are usually used for forensics after a damaging incident.

There are inherent problems in this prior art configuration. An initial problem results from the distribution of the HIDS logs. The distribution of the logging information makes it difficult to analyze the network activity in real time or near real time and to analyze it collectively to better understand the activity over the entire network. Additionally, HIDS from different applications and/or operations system are in different formats. This makes it difficult to automatically analyze them even if they were collected at a central location for cross-examination and determining correlations.

An additional problem in the prior art results from the distribution of the access control lists. Because each application maintains its own access control list, implementation of changes in corporate policy are difficult and laborious. Additionally, unless the application supports it, granular per method access control (to expose only limited functionality of an application to the user) cannot be provided. Most applications only support rudimentary features in this regard. Many do not provide any control. Thus, the network architects have no choice but to either ignore some corporate security policies, resist inclusion of policies that ask for such control, or develop expensive customized code for implementing such policies. Integrating of applications from different vendors is usually a non-trivial effort.

Firewalls and IDS solutions fall short of serving the needs of application security requirements. Neither system authenticates users. Firewalls unintelligently block ports and IP addresses and do not allow granular access control based on functionality. IDS rule sets are difficult to adjust. NIDS are less effective at detecting insider attacks. HIDS is better but its distributed nature makes it a formidable choice.

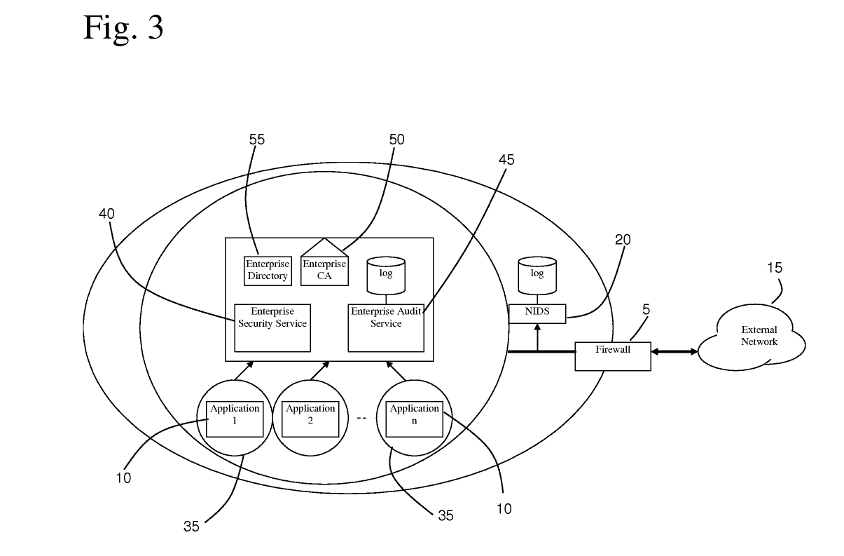

With reference to FIG. 3, a method and system of providing role-based authorization, granular access control and exhaustive centralized audit trails in accordance with the present invention is illustrated. The present invention provides a comprehensive role based, time-based, and context-based authorization solution. As such, the system and method of the present invention is effective in providing protection for enterprise applications and information assets from attacks originating from both inside and outside the enterprise network.

For critical transactions, non-repudiation service is provided through the use of digital signatures. Such transactions are always logged in order to provide a completely irrefutable transaction history for use in the court as a proof of transaction. The present invention provides centralized and standardized high quality audit trail information for intrusion and anomaly detection, incident response, and forensics analysis.

A particular embodiment of the invention is installed as an add-on to existing applications (on separate physical machines) including legacy applications. The focus lies with seamless integration, rather than application modification. Implementation of an embodiment of the present invention is also a scalable solution by architecture. For these reasons, it can be phased-in into an enterprise gradually without interrupting critical operations. The present invention enhances the utility of modern and legacy applications by providing all these features. With better security control, more applications can be integrated with the web servers and provide web services.

An embodiment of this invention provides a number of security interceptors. When fully deployed, each application is protected by a separate instance of a security interceptor. The interceptor intercepts all calls to the application, logs the activity in a central database with a uniform format, provides consistent single sign-on features, and allows access control from a centralized security policy server.

These security interceptors can also act as communication protocol converters that allow applications requiring different communication protocol to be integrated into the system. Unlike prior art security proxies; these interceptors provide a comprehensive set of services that are important for all aspects of application security. They require no modification to the conventional/legacies applications and can be deployed without disrupting on-going operations of the enterprise.

FIG. 3 shows the setup of the application frameworks in form of circles 35 that wrap each of the applications 10. They also intercept all calls to the legacy applications. Users authenticate to the enterprise Security Service 40 by providing their authentication credentials (password, certificate or hardware token). Security service logs these request with the audit service 45 and then verifies the credentials with the help of Enterprise CA 50.

After successfully authenticating, when a user accesses an application 10 for the first time, the interceptor first logs this request with the Audit service 45 (it logs all subsequent requests as well) and then contacts the security service 40 to obtain the privileges of the user. Security service obtains these privileges from the Enterprise Directory Service 55. The security interceptor 35 then stores the list it obtains from the security service 40 for a predetermined time. If the list of privileges indicates that the particular access to the application is permitted for that the user, the interceptor forwards that request to the application 10. When the application 10 provides results of the request, interceptor forwards the results to the client.

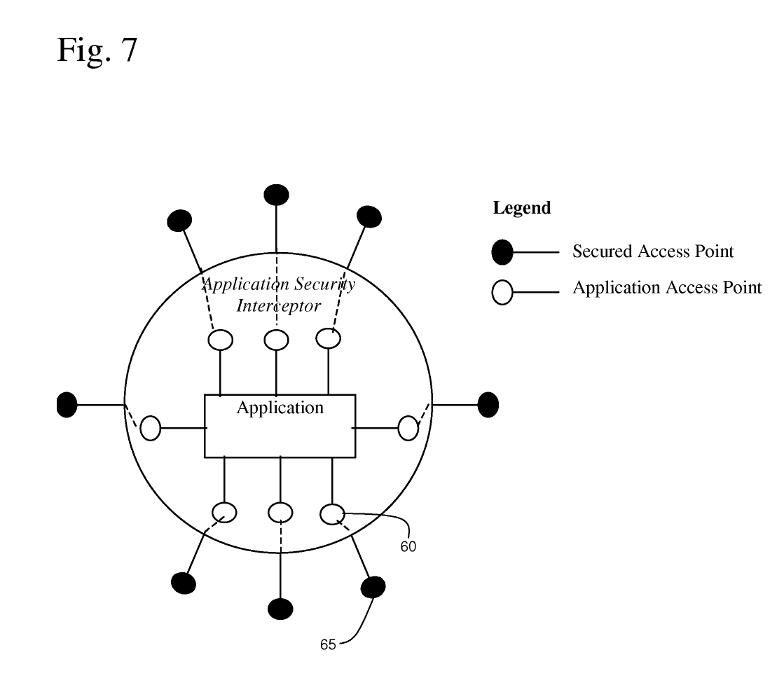

Security interceptors also make it simple to provide granular control of the access to applications. This concept is depicted in FIG. 7. Each access point of the application 60 (indicated by empty circles) is independently controlled by the interceptor 10. For every original public access point of the application 60, security interceptor provides a secured access point 65 (indicated by solid circles). Permission is granted to access the application only if the privileges permit it for the particular user with optional limitation on the range of parameters within those access points.

Since the security interceptor intercepts all service-requests made to the application, it can selectively block the requests. With this architecture, it is possible to provide dynamic context based access control. Since the interceptor does not maintain permissions locally but downloads them from the central security service, the corporate policy can be controlled centrally. Since the security interceptor downloads the permissions dynamically at run time rather than at deployment time, the corporate policy can be changed on the fly and it can be modified to handle more complex scenarios. These policies can even be generated on by automatic or semi automatic application that implements the “general” security guidelines provided by the corporation.

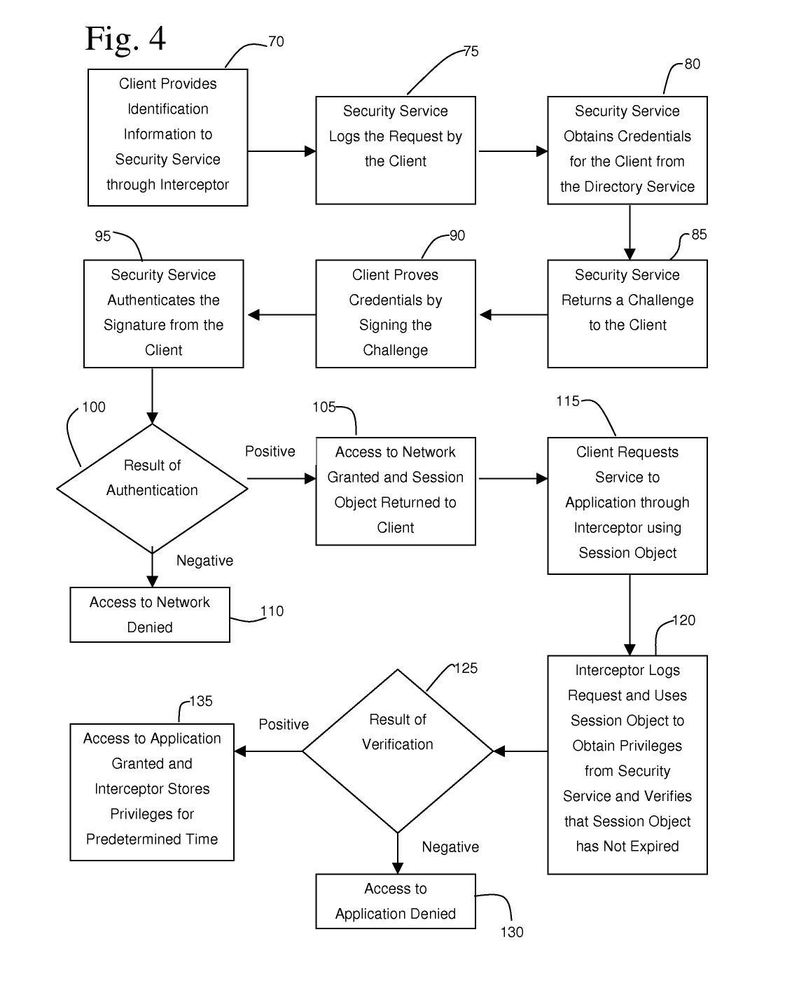

The authentication process of one embodiment in accordance with the present invention is depicted in FIG. 4. According to this embodiment, the user or client entity indicates to the security service that it wants to authenticate by providing its identification information 70. Security Service logs his request 75 and obtains the credentials from directory service 80. A random challenge is returned to the client 85 so that it can prove its credentials by signing the challenge 90. One embodiment of this signature can be the digital signature produced by private key of the client. This process is only simplistic representation of the actual process. Actual process is more complex than one described here, but it is well known in the prior art.

Security service then verifies the signature on the challenge 95 (e.g. by verifying the digital signature using the public key of the user obtained from a digital certificate). If the verification is positive, a session object is returned that also contains the roles that are permitted for the client based on the credentials that user provides 105. Client then “asserts” any one, some, or all of the roles. Security Service then builds an access control lists (permissions) for that user and maintains that object till the lifetime of current session. If the verification is negative, access is denied 110.

Once the client has authenticated with the security service, it can make service requests (calls) to the service through Security interceptors of the application. The client must send the session object that was returned to it by the security service along with the request 115. The interceptor first logs this request and then obtains the “permissions” (access control lists) maintained by the security service against that session object 120. The interceptor also verifies if the session object has expired. If the type of request and its parameters are permitted, and the session object has not expired, the request is forwarded to the application 135. If the requirements are not met, access to the application is denied 130.

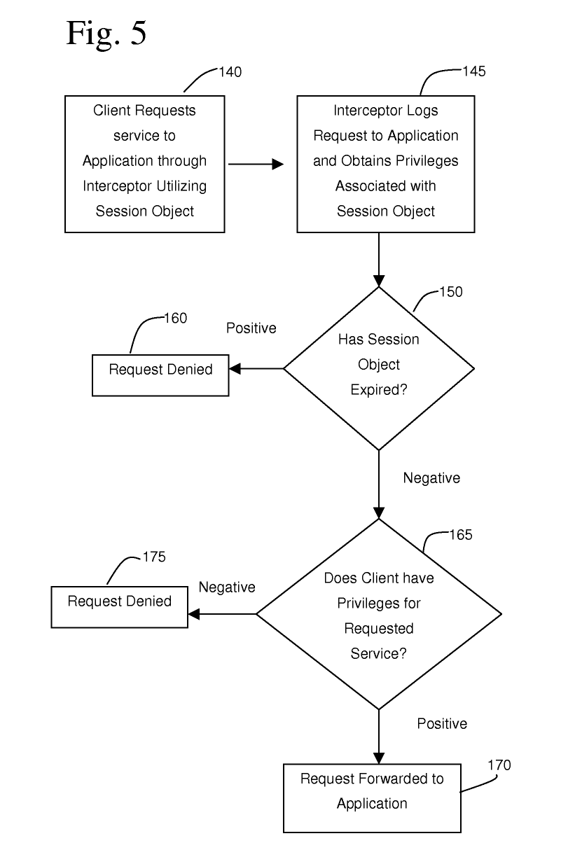

Requests to the application are handled by the interceptors as depicted in FIG. 5. As illustrated in this particular embodiment, a client request service to the application through the interceptor utilizing the session object 140. The interceptor then logs the request and obtains the privileges associated with the session object 145. The interceptor then verifies whether or not the session object has expired 150. If the session has expired, the request is denied 160. If the session has not expired, the interceptor then determines whether or not the client has privileges for the requested service 165. If the client does not have appropriate privileges, access to the application is denied 175. If the privileges are available to the client, the request is forwarded to the application 170.

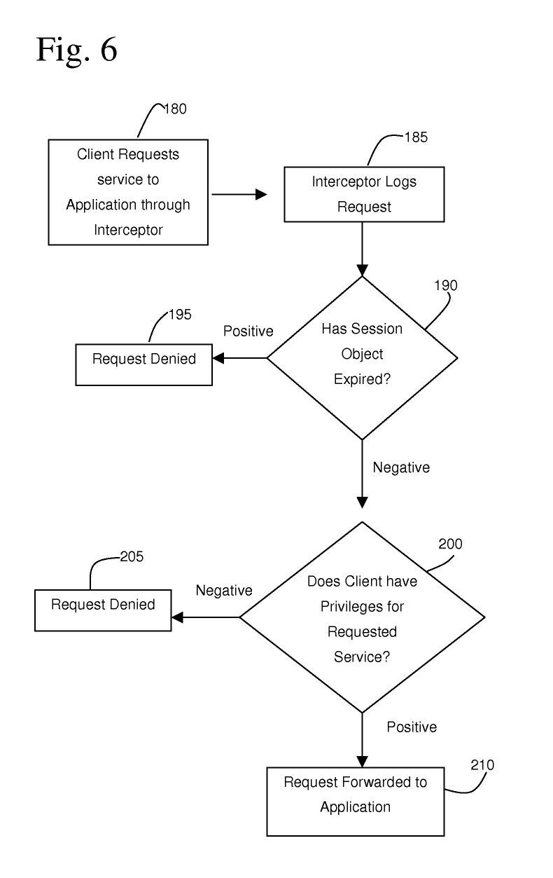

Subsequent requests made on the application are handled entirely by the security interceptor without any need to consult with the security service. The use case of these accesses is depicted in FIG. 6. As shown, a client requests service to an application through the interceptor 180. The interceptor logs the request 185 and then determines whether or not the session object has expired 190. If the object has expired, the request is denied 195. If the object is active, the interceptor then determines the privileges for the requested service 200. If the client has the appropriate privileges, the request is forwarded to the application 210, otherwise the request is denied 205.

The invention proposes a simple three-step process for moving a company's IT infrastructure under a single secure umbrella.

1. Define a comprehensive security policy. Security policy definition starts with the analysis of business processes and defining the weak links in the information chain that can be susceptible to attacks. Different organizational roles are analyzed and privileges associated with each are isolated. Any other parameters are also resolved at this stage to finalize the policy.
2. Configure the embodiment of this invention system. The core services of an embodiment of this invention are configured to mirror the organizational structure defined in the first step. Thus a digital version of the organization is formed.
3. Integrate applications and protocols. A variety of application frameworks are provided to facilitate the rapid integration of existing applications with the core services. Application programmers can develop new applications independently and integrate them with the security frameworks at the end. Even legacy applications can be integrated using a well-defined approach that enables them to enjoy all of the platform benefits.

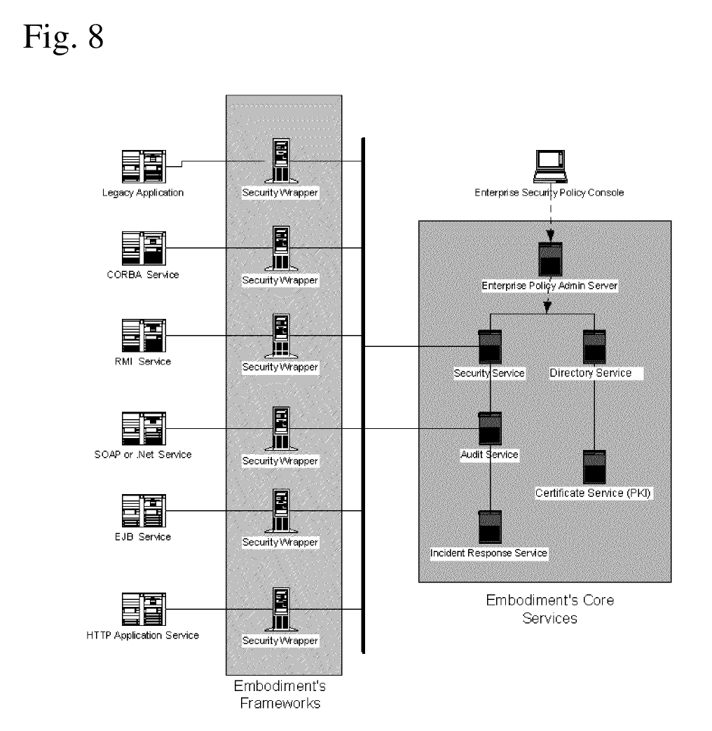

An embodiment of this invention is based on a suite of six services and a set of security frameworks as shown in FIG. 8. This configuration forms a comprehensive application security platform. Most of the services are ready to be deployed out-of-the-box and need minimal configuration for enterprise-wide operation. A flexible framework supports rapid deployment and customization requirements.

The embodiment provides an ensemble of all the essential services required for implementing enterprise wide security.

The services include:

1. A certificate server allowing an organization to setup its own Public Key Infrastructure (PKI). It removes trust dependencies and licensing costs on external certificate authorities. The certificates may optionally be stored on a smart card.
2. A directory server, which may be a JNDI compliant directory server using LDAP as the base protocol. It stores the user credentials, roles, authentication mechanisms, and access control information. Multiple instances can be used for load balancing and hot fail over.
3. An Audit server that logs all the crucial activity information to provide system accountability in a single repository using a uniform format that is easier to analyze and process.
4. A security server that is responsible for security policy enforcement. It authenticates users, dispenses role and access control information, creates user sessions, and provides a broad set of information necessary for enforcing the security policy. It uses the directory service to store the public user credentials.
5. An enterprise policy administration server that is used for editing the security policy information. It supports creation, modification, credentials revocation, user role editing and providing means for implementation of other advanced functions.
6. An incident response server. This server continuously watches over other services to look for catastrophic failures. It sends out immediate alerts if a failure is detected. Multiple instances are used for hot fail over.
7. Application proxy frameworks providing a set of frameworks to secure RMI, CORBA, EJB, HTTP and SOAP protocols. They allow for rapid integration with applications implemented using these standard protocols. Frameworks for legacy applications protection are also available.

It will be seen that the advantages set forth above, and those made apparent from the foregoing description, are efficiently attained and since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall there between. Now that the invention has been described,

What is claimed is:

1. A method of providing enterprise application security, the method comprising:
a. receiving a request from a client to provide access to the client to a single or plurality of applications within an enterprise's internal network, wherein the request has identification information of the client and the request is received inside the enterprise's internal network;
b. obtaining the client's credentials from a directory service;
c. verifying the client's identity;
d. creating a session object for the purpose of getting access to one or plurality of interceptors each designed to secure a single said application, containing the identification information of the client and at least a first role permitted for the client based on the client's credentials, responsive to a positive verification of the client's identity;
e. returning the session object to the client;
f. receiving at least a first asserted role from the client that specifies access privileges to the said single or plurality of applications;
g. assigning the permissions associated with the asserted role from the client's credentials; and
h. storing the permissions locally;
whereby the said object will be subsequently be used for gaining access to the said applications under the access privileges permitted by the said roles.

2. A method of providing enterprise application security, the method comprising:
a. intercepting a service request from a client to an application on an enterprise's internal network, wherein the said request is intercepted inside the enterprise's internal network by an interceptor designed to intercept all requests for the said application and operating inside an enterprise's internal network;
b. receiving a session object containing roles permitted for the client along with the service request;
c. determining if the said client's session object is valid; and
d. forwarding the service request to the said application responsive to a determination that the said client's session object is valid;
